(19) United States
(12) Patent Application Publication
(10) Pub. No.: US 2020/0343940 A1
(43) Pub. Date: Oct. 29, 2020

(54) LOW POWER RADIO-FREQUENCY LOCALIZATION

(71) Applicant: Humatics Corporation, Waltham, MA (US)

(72) Inventors: Gregory L. Charvat, Guilford, CT (US); Senter Reinhardt, Waltham, MA (US)

(21) Appl. No.: 16/856,643

(22) Filed: Apr. 23, 2020

Related U.S. Application Data
(60) Provisional application No. 62/839,445, filed on Apr. 26, 2019.

(51) Int. Cl. H04B 3/52; H04B 1/48; H04B 3/54; H01Q 13/24; G06K 7/00

(52) U.S. Cl. CPC H04B 3/52; H04B 1/48; G06K 7/0008; H01Q 13/24; H04B 3/54

(57) ABSTRACT

A device comprising: a receive antenna configured to receive radio-frequency (RF) signals having a first center frequency; a transmit antenna configured to transmit radio-frequency (RF) signals having a second center frequency that is a harmonic of the first center frequency; and a processor. The processor is configured to: generate a plurality of wake-up signals at a respective plurality of random times; and for each one of the plurality of wake-up signals, in response to generating the each one wake-up signal, cause the transmit antenna to transmit an RF signal having the second center frequency and indicating a code associated with the device to an interrogator device different from the device.

### CROSS REFERENCE TO RELATED APPLICATIONS

This application claims the benefit of priority under 35 U.S.C. § 119(e) to U.S. Provisional Application Ser. No. 62/839,445, filed on Apr. 26, 2019, titled “LOW POWER RADIO-FREQUENCY LOCALIZATION,” which is incorporated by reference herein in its entirety.

### BACKGROUND

The ability to accurately determine the location of an object or target has potential benefits for numerous applications. Some exemplary applications benefitting from object localization include motion tracking, virtual reality, gaming, autonomous systems, robotics, etc. A number of technologies have been pursued that seek to provide localization, including global positioning system (GPS) technology, received signal strength indicator (RSSI) measurements, optical image data processing techniques, infrared ranging, etc. Generally, these conventional approaches are limited in application due to one or more deficiencies, including relatively poor or insufficient accuracy and/or precision, computational complexity resulting in relatively long refresh rates, environmental limitations (e.g., operation limited to outdoors, cellular or network access requirements and/or vulnerability to background clutter or noise), cost, size, etc.

### SUMMARY

Some embodiments provide for a device comprising: a receive antenna configured to receive radio-frequency (RF) signals having a first center frequency; a transmit antenna configured to transmit radio-frequency (RF) signals having a second center frequency that is a harmonic of the first center frequency; and a processor. The processor is configured to: generate a plurality of wake-up signals at a respective plurality of random times; and for each one of the plurality of wake-up signals, in response to generating the each one wake-up signal, cause the transmit antenna to transmit an RF signal having the second center frequency and indicating a code associated with the device to an interrogator device different from the device. In some embodiments, the processor is configured to generate the plurality of wake-up signals using a pseudo-random number generator. In some embodiments, the processor is configured to generate the plurality of wake-up signals such that a wake-up signal is generated, on average, at a rate equal to a specified ping rate. In some embodiments, the specified ping rate is a rate in a range of 0.1 Hz and 200 Hz. In some embodiments, the specified ping rate is a rate of approximately 1 Hz. In some embodiments, the processor is configured to generate the plurality of wake-up signals such that a time between successive wake-up signals is, on average, approximately a specified duration. In some embodiments, the specified duration is 1 second.

In some embodiments, the device includes a motion sensor, the rate is a first rate, and the processor is configured to change a frequency at which it generates the plurality of wake-up signals from the first rate to a second rate in response to motion of the device being detected using the motion sensor. In some embodiments, the motion sensor comprises an accelerometer. or an inertial measurement unit (IMU). In some embodiments, the processor is configured to change the frequency at which it generates the plurality of wake-up signals from the second rate to the first rate after a threshold amount of time has elapsed from when the motion of the device was detected using the motion sensor.

In some embodiments, the processor is configured to cause the transmit antenna to transmit the RF signal having the second center frequency at least in part by: modulating a received RF signal received by the receive antenna using the code associated with the device. In some embodiments, the processor is configured to amplitude modulate the received RF signal using the code associated with the device. In some embodiments, the processor is configured to phase modulate the received RF signal using the code associated with the device. In some embodiments, the received RF signal is a continuous wave RF signal having the first center frequency.

In some embodiments, the device includes: a substrate and the receive antenna and the transmit antenna are fabricated on the substrate. In some embodiments, the device also includes a semiconductor die mounted on the substrate; and circuitry integrated with the semiconductor die mounted on the substrate and configured to: generate, from RF signals provided from the receive antenna and having the first center frequency, RF signals having the second center frequency, and provide the generated RF signals having the second center frequency to the second transmit antenna.

In some embodiments, wherein the first center frequency is in a range of 50-70 GHz and the second center frequency is in a range of 100-140 GHz. In some embodiments, the first center frequency is approximately 60 GHz and the second center frequency is approximately 120 GHz. In some embodiments, the first center frequency is in a range of 4-7.5 GHz and the second center frequency is in a range of 8-15 GHz.

In some embodiments, the receive antenna is configured to receive RF signals circularly polarized in a first rotational direction and the transmit antenna is configured to transmit RF signals circularly polarized in a second rotational direction different from the first rotational direction.

In some embodiments, the processor is a low-power processor. In some embodiments, the device is configured to operate at less than 1 milliWatt. In some embodiments, the device is configured to operate at less than 500 microWatts.

Some embodiments provide for a method performed by a device comprising a receive antenna configured to receive RF signals having a first center frequency, a transmit antenna configured to transmit RF signals having a second center frequency that is a harmonic of the first center frequency, and a processor. The method comprises: generating a plurality of wake-up signals at a respective plurality of random times; and for each one of the plurality of wake-up signals, in response to generating the each one wake-up signal, causing the transmit antenna to transmit an RF signal having the second center frequency and indicating a code associated with the device to an interrogator device different from the device.

In some embodiments, generating the plurality of wake-up signals is performed using a pseudo-random number generator. In some embodiments, generating the plurality of wake-up signals comprises generating a wake-up signal, on average, at a rate equal to a specified ping rate. In some embodiments, the specified ping rate is in a range of 0.1 Hz and 200 Hz. In some embodiments, generating the plurality of wake-up signals is performed such that a time between successive wake-up signals is, on average, approximately a specified duration. In some embodiments, the specified duration is 1 second.

In some embodiments, the device includes a motion sensor, wherein the rate is a first rate, and wherein generating the plurality of wake-up signals is performed at a second rate higher than the first rate in response to motion of the device being detected using the motion sensor. In some embodiments, generating the plurality of wake-up signals is performed at a first rate instead of the second rate after a threshold amount of time has elapsed from when the motion of the device was detected using the motion sensor.

In some embodiments, causing the transmit antenna to transmit the RF signal having the second center frequency comprises modulating a received RF signal received by the receive antenna using the code associated with the device. In some embodiments, modulating the received RF signal comprises pulse modulating the received RF signal using the code associated with the device. In some embodiments, modulating the received RF signal comprises amplitude modulating the received RF signal using the code associated with the device. In some embodiments, modulating the received RF signal comprises phase modulating the received RF signal using the code associated with the device. In some embodiments, the received RF signal is a continuous wave RF signal having the first center frequency.

In some embodiments, the plurality of wake-up signals includes a first wake-up signal, the method further comprising: in response to generating the first wake-up signal, causing the transmit antenna to transmit a first RF signal having the second center frequency and indicating the code associated with the device to the interrogator device, after transmitting the first RF signal, receiving, from the interrogator device, a second RF signal having the first center frequency; generating, using the second RF signal and signal transformation circuitry part of the target device, a third RF having the second center frequency; and transmitting, to the interrogator device, the third RF signal having the second center frequency.

In some embodiments, the first center frequency is in a range of 50-70 GHz and the second center frequency is in a range of 100-140 GHz. In some embodiments, the first center frequency is approximately 60 GHz and the second center frequency is approximately 120 GHz. In some embodiments, the first center frequency is in a range of 4-7.5 GHz and the second center frequency is in a range of 8-15 GHz.

Some embodiments provide for an interrogator device, comprising: a transmit antenna configured to transmit RF signals having a first center frequency; a receive antenna configured to receive RF signals having a second center frequency that is a harmonic of the first center frequency; circuitry configured to provide RF signals to the transmit antenna and receive RF signals from the receive antenna; and a controller configured to, in response to determining that the interrogator device received a first RF signal indicating a first code associated with a first target device, cause the interrogator device to: transmit a second RF signal to the first target device using the transmit antenna, the second RF signal having the first center frequency; receive a third RF signal from the first target device, the third RF signal having the second center frequency; and generate, based on the second RF signal and the third RF signal, a fourth RF signal indicative of a time-of flight and/or distance between the interrogator device and the first target device.

In some embodiments, the controller is further configured to, in response to determining that the interrogator device received a fifth RF signal indicating a second code associated with a second target device, cause the interrogator device to: transmit a sixth RF signal to the second target device using the transmit antenna, the sixth RF signal having the first center frequency; receive a seventh RF signal from the second target device, the seventh RF signal having the second center frequency; and generate, based on the sixth RF signal and the seventh RF signal, an eighth RF signal indicative of a time-of flight and/or distance between the interrogator device and the second target device.

In some embodiments, the second RF signal is a linear frequency modulated signal. In some embodiments, the sixth RF signal is a linear frequency modulated signal. In some embodiments, the interrogator device is configured to generated the fourth RF signal by mixing the second RF signal and the third RF signal using a mixer part of the circuitry.

Some embodiments provide for a method performed by an interrogator device having a transmit antenna configured to transmit RF signals having a first center frequency, a receive antenna configured to receive RF signals having a second center frequency that is a harmonic of the first center frequency. The method comprises: transmitting, using the transmit antenna, a first RF signal; receiving, using the receive antenna and from a first target device, a modulated version of the first RF signal, the modulated version of the first RF signal indicating a first code associated with the first target device; in response to receiving the modulated version of the first RF signal, transmitting, using the transmit antenna and to the first target device, a second RF signal having the first center frequency; receiving, using the receive antenna and from the first target device, a third RF signal having the second center frequency; and generating, based on the second RF signal and the third RF signal, a fourth RF signal indicative of a time-of flight and/or a distance between the interrogator device and the first target device.

In some embodiments, identifying the first code associated with the first target device from the modulated version of the first RF signal. In some embodiments, the method further includes determining a distance between the interrogator device and the first target device; and storing the distance in association with the first code. In some embodiments, transmitting the second RF signal is performed in response to receiving the modulated version of the first RF signal and determining that the first code is one of a specified plurality of target device codes. In some embodiments, the method further includes transmitting, using the transmit antenna, a fifth RF signal; receiving, using the receive antenna and from a second target device different from the first target device, a modulated version of the fifth RF signal, the modulated version of the fifth RF signal indicating a second code associated with the second target device; in response to receiving the modulated version of the fifth RF signal, transmitting, using the transmit antenna and to the second target device, a sixth RF signal having the first center frequency; receiving, using the receive antenna and from the second target device, a seventh RF signal having the second center frequency; and generating, based on the sixth RF signal and the seventh RF signal, an eighth RF signal indicative of a time-of flight and/or a distance between the interrogator device and the second target device.

Some embodiments provide for a device comprising: a receive antenna configured to receive radio-frequency (RF) signals having a first center frequency; a transmit antenna configured to transmit radio-frequency (RF) signals having a second center frequency that is a harmonic of the first center frequency; a motion sensor (e.g., an IMU, accelerometer, gyroscope) configured to detect motion of the device; and a processor configured to: generate a wake-up signal in response to detecting motion of the device by the motion sensor; and in response to generating the wake-up signal, cause the transmit antenna to transmit an RF signal having the second center frequency and indicating a code associated with the device to an interrogator device different from the device.

Some embodiments provide for a method, performed by a device comprising a receive antenna configured to receive RF signals having a first center frequency, a transmit antenna configured to transmit RF signals having a second center frequency that is a harmonic of the first center frequency, a motion sensor configured to detect motion of the device. The method comprises: detecting motion of the device using the motion sensor; generating a wake-up signal in response to detecting motion of the device; and in response to generating the wake-up signal, causing the transmit antenna to transmit an RF signal having the second center frequency and indicating a code associated with the device to an interrogator device different from the device.

### BRIEF DESCRIPTION OF DRAWINGS

Various aspects and embodiments will be described with reference to the following figures. It should be appreciated that the figures are not necessarily drawn to scale.

FIG. 1A shows an illustrative system 100 that may be used to implement radio frequency (RF) localization techniques, in accordance with some embodiments of the technology described herein.

FIG. 1B shows another illustrative system 150 that may be used to implement RF localization techniques, in accordance with some embodiments of the technology described herein.

FIG. 2A shows illustrative components of an interrogator device and a target device having a dedicated control channel, which may be part of the illustrative system 150 shown in FIG. 1B, in accordance with some embodiments of the technology described herein.

FIG. 2B shows illustrative components of an interrogator device and a low-power target device without a dedicated control channel, which may be part of the illustrative system 150 shown in FIG. 1B, in accordance with some embodiments of the technology described herein.

FIG. 3A shows illustrative components of a low-power target device 300, in accordance with some embodiments of the technology described herein.

FIG. 3B is a timing diagram illustrating when power is provided to multiple components of the low-power target device 300, in accordance with some embodiments of the technology described herein.

FIG. 4A shows illustrative components of a single-channel interrogator transmitter/receiver 400 providing both real and imaginary (quadrature) data, in accordance with some embodiments of the technology described herein.

FIG. 4B illustrates aspects of interrogator behavior when a target device randomly turns on, pulses its code, and remains on so as to be ranged with a linear FM chirp, in accordance with some embodiments of the technology described herein.

FIG. 5A shows illustrative components of a single-channel interrogator transmitter receiver 500 providing real data, in accordance with some embodiments of the technology described herein.

FIG. 5B shows an illustrative range-time-intensity plot of a real signals received by an interrogator device from a target device randomly turning on, pulsing its code, and remaining on so as to be ranged with a linear FM chirp, in accordance with some embodiments of the technology described herein.

### DETAILED DESCRIPTION

Determining the location of an object with a high degree of accuracy and precision has an array of applications in a variety of fields including autonomous vehicle navigation, robotics, virtual reality, motion tracking, and motion capture. Some applications require localization techniques capable of resolving the location of an object in the millimeter and sub-millimeter range. Such techniques are referred to herein generally as micro-localization techniques.

Some micro-localization techniques use radio-frequency (RF) signals to determining the location of an object. For example, a micro-localization system may include an interrogator device configured to transmit an RF signal (e.g., a microwave or millimeter wave RF signal) and a target device (e.g., a transponder) configured to, in response to receiving the RF signal, transmit an RF signal to be received by the interrogator device. The RF signal received from the target device may be used (e.g., by the interrogator device) together with a version of the transmitted RF signal to determine the time-of-flight between the interrogator and the target devices, and in turn the distance between them. Examples of such micro-localization systems are described in U.S. Pat. No. 9,797,988 titled “RADIO FREQUENCY LOCALIZATION TECHNIQUES AND ASSOCIATED SYSTEMS, DEVICES, AND METHODS” dated Oct. 24, 2017, which is herein incorporated by reference in its entirety.

The inventors have recognized and appreciated that some applications of micro-localization techniques demand that the target device operate on its own power for a prolonged period of time. Such long lifetime target devices could be used for applications such as shipping labels (where a target device may be part of a shipping label, for example), worker tracking and access control (where a target device may be part of an employee's identification badge). In some of these applications, it is desirable for the target device to have a life expectancy of one or more weeks, one or more months, approximately a year, or even more than a year. Notwithstanding the long life-expectancy and low-power requirements, a micro-localization system should have high precision and work well against multi-path, which is an obstacle to deploying RF-based systems in indoor environments.

To address the above needs, the inventors have developed a low-power long life-expectancy RF micro-location system. The system can be used for a number of applications including, but not limited to tracking movement of people in a building, providing access control (e.g., by positioning one or more interrogators near a door, which would be automatically unlocked when the interrogators determine that a target device within an ID badge of an authorized employee is within a threshold distance of the door), tracking packages with shipping labels, and numerous other applications.

To provide a low-power long-life expectancy RF micro-location system, the inventors have developed a low-power target device (e.g., a transponder) without a dedicated control channel and configured to draw power from an onboard battery. While a dedicated control channel allows for remotely controlling the operation of the target device, it consumes a significant amount of power—it's inclusion in a target device would reduce the life expectancy of the target device. Accordingly, the inventors have developed a target device that proactively wakes up, sends out transmission identifying itself (e.g., using on-off keying), and leaves itself on for long enough to be ranged by one or more interrogator devices (e.g., using an LFM waveform). Such a target device consumes significantly less power than a target device with a dedicated control channel.

In some embodiments, the device pro-actively wakes up at random times according to a randomized schedule. For example, the device may proactively wake up approximately every one second or at any other suitable rate. In some embodiments, the device may proactively wake up in response to a trigger. For example, in some embodiments, the device may include at least one motion sensor (e.g., one or more accelerometers, one or more gyroscopes, and/or one or more inertial measurement units (IMUs)). In some such embodiments, responsive to detection of motion by the at least one motion sensor (e.g., after the device is bumped and/or moved), the device may either: (1) wake itself up, send one or more transmissions identifying itself (e.g., using on-off keying), and leave itself on for long enough to be ranged by one or more interrogator devices; or (2) change the randomized schedule that causes the device to pro-actively wake up to cause the device to wake-up at a higher frequency than it would according to the original schedule. In the second case, for example, the device may be operating to wake-up and send one or more transmissions identifying itself according to a randomized schedule having a long average time between wake-ups (e.g., approximately 10 seconds). However, in response to detecting motion, the device may change the randomized schedule to have a shorter average time between wake-ups (e.g., approximately 0.5 seconds or 1 second). In some embodiments where the randomized schedule is changed responsive to the detection of motion using the motion sensor(s), the randomized schedule may stay changed (causing a higher frequency of wake-ups) until a threshold amount of time (e.g., 5 seconds, 30 seconds, 1 minute, 5 minutes, ten minutes, twenty minutes, any threshold period of time in the range of 5 seconds to twenty minutes) after the motion sensor(s) stop detect detecting movement.

Accordingly, some embodiments provide for a device comprising: a receive antenna configured to receive radio-frequency (RF) signals having a first center frequency (e.g., 60 GHz); a transmit antenna configured to transmit radio-frequency (RF) signals having a second center frequency that is a harmonic of the first center frequency (e.g., 120 GHz); and a processor (e.g., a low power micro-processor or micro-controller) configured to: generate a plurality of wake-up signals at a respective plurality of random times; and for each one of the plurality of wake-up signals, in response to generating the each one wake-up signal, cause the transmit antenna to transmit an RF signal having the second center frequency and indicating a code (e.g., a unique code) associated with the device to an interrogator device different from the device.

In some embodiments, the processor is configured to generate the plurality of wake-up signals using a pseudo-random number generator. In some embodiments, The device of claim 1, wherein the processor is configured to generate the plurality of wake-up signals such that a wake-up signal is generated, on average, at a rate equal to a specified ping rate (e.g., a rate in the range of 0.1 Hz and 200 Hz, approximately 1 Hz).

In some the processor is configured to generate the plurality of wake-up signals such that a time between successive wake-up signals is, on average, approximately a specified duration (e.g., 1 second).

In some embodiments, the device may include one or more motion sensor(s) and the processor may be configured to change (e.g., increase) the rate at which it generates the plurality of wake-up signals from a first rate (e.g., 0.1 Hz) to a second rate (e.g., 2 Hz), in response to motion of the device being detected using the motion sensor(s). In some embodiments, the processor may be configured to change (e.g., decrease) the rate at which it generates the plurality of wake-up signals from the second rate (e.g., 2 Hz) back to the first rate (e.g., 0.1 Hz) after a threshold amount of time (e.g., one minute, five minutes, ten minutes, etc.) elapses from at time at which the motion sensor(s) stop sensing motion.

In some embodiments, the processor is configured to cause the transmit antenna to transmit the RF signal having the second center frequency at least in part by: modulating (e.g., using on-off key (OOK) modulation, amplitude modulation, pulse modulation, phase modulation) a received RF signal received by the receive antenna using the code associated with the device.

In some embodiments, the device further includes a substrate, with the receive antenna and the transmit antenna are fabricated on the substrate. In some embodiments, the device further includes a semiconductor die mounted on the substrate; and circuitry integrated with the semiconductor die mounted on the substrate and configured to: generate, from RF signals provided from the receive antenna and having the first center frequency, RF signals having the second center frequency, and provide the generated RF signals having the second center frequency to the second transmit antenna.

In some embodiments, the receive antenna is configured to receive RF signals circularly polarized in a first rotational direction and the transmit antenna is configured to transmit RF signals circularly polarized in a second rotational direction different from the first rotational direction.

In some embodiments, the device is configured to operate at a DC power in a range of 4 microWatts-20 milliWatts, 100 microWatts-10 milliWatts, 250 microWatts-5 milliWatts, less than 1 milliWatt and/or at less than 500 microWatts.

Some embodiments provide for a device comprising: a receive antenna configured to receive radio-frequency (RF) signals having a first center frequency; a transmit antenna configured to transmit radio-frequency (RF) signals having a second center frequency that is a harmonic of the first center frequency; a motion sensor configured to detect motion of the device; and a processor configured to: generate a wake-up signal in response to detecting motion of the device by the motion sensor; and in response to generating the wake-up signal, cause the transmit antenna to transmit an RF signal having the second center frequency and indicating a code associated with the device to an interrogator device different from the device. In some embodiments, the motion sensor may include an accelerometer, an inertial measurement unit (IMU), a gyroscope, and/or any other suitable motion sensor(s).

It should be appreciated that the techniques introduced above and discussed in greater detail below may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

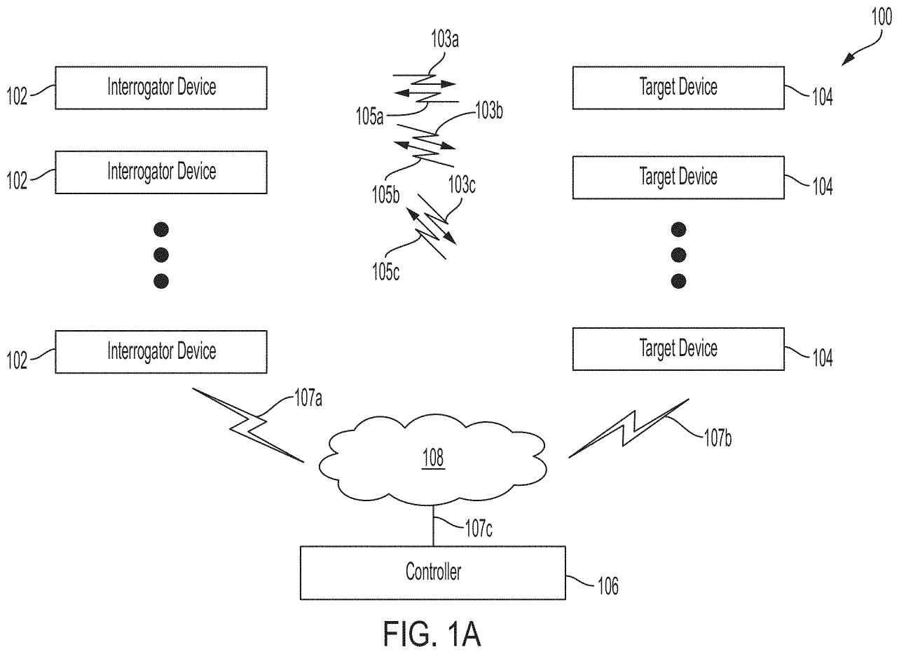

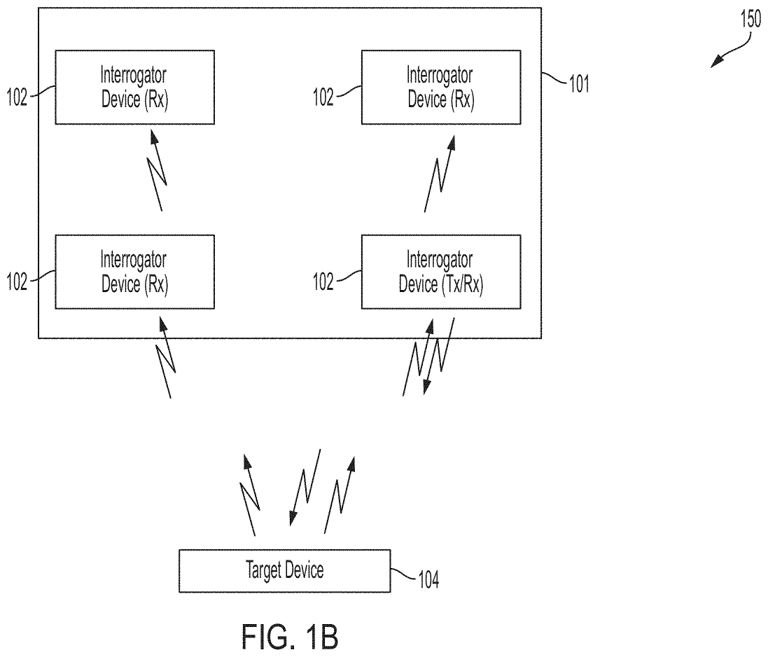

FIG. 1A illustrates an exemplary micro-localization system 100, in accordance with some embodiments. Micro-localization system 100 comprises a plurality of interrogator devices 102, one or more of which are configured to transmit an RF signal 103 (e.g., RF signals 103a, 103b, 103c, etc.). Micro-localization system 100 also comprises one or more target devices 104 configured to receive RF signals 103 and, in response, transmit RF signals 105 (e.g., RF signals 105a, 105b and 105c, etc.). Interrogator devices 102 are configured to receive RF signals 105 that are then used to determine distances between respective interrogator and target devices. The computed distances may be used to determine the location of one or more target devices 104. It should be appreciated that while multiple target devices 104 are illustrated in FIG. 1A, a single target device may be utilized in some circumstances. More generally, it should be appreciated that any number of interrogator devices 102 and target devices 104 may be used, as the aspects of the technology described herein are not limited in this respect.

Micro-localization system 100 may also include a controller 106 configured to communicate with interrogator devices 102 and target devices 104 via communication channel 108, which may include a network, device-to-device communication channels, and/or any other suitable means of communication. Controller 106 may be configured to coordinate the transmission and/or reception of RF signals 103 and 105 between desired interrogator and target devices via communication channels 107a, 107b and 108, which may be a single communication channel or include multiple communication channels. Controller 106 may also be configured to determine the location of one or more target devices 104 from information received from interrogator devices 102. Controller 106 may be implemented as a standalone controller or may be implemented in full or in part by one or more interrogator devices 102 and/or target devices 104.

According to some embodiments, one or more interrogator devices transmit first RF signals (e.g., RF signals 103) having a first center frequency and, in response to receiving the first RF signals, one or more target devices transmit second RF signals (e.g., RF signals 105) having a second center frequency different from the first center frequency. In this manner, receive antennas on the one or more interrogator devices can be configured to respond to RF signals about the second center frequency, improving the ability of the interrogator devices to receive RF signals from target devices in cluttered and/or noisy environments.

In some embodiments, relatively simple and/or cost effective circuitry could be implemented at the target device to transform RF signals having a first center frequency received from an interrogator device to RF signals having a second center frequency different from the first center frequency for transmission. According to some embodiments, the second center frequency is harmonically related to the first center frequency. For example, in system 100 illustrated in FIG. 1A, a target device 104 may be configured to transform RF signals 103 and transmit RF signals 105 at a harmonic of the center frequency of the received RF signal 103. According to other embodiments, a target device transforms RF signals having a first center frequency received from an interrogator device to RF signals having second center frequency that is different from, but not harmonically related to the first center frequency. In other embodiments, a target device is configured to generate RF signals at a second center frequency different from the first center frequency, either harmonically or not harmonically related, rather than transforming RF signals received from an interrogator device.

As described above with reference to FIG. 1A, multiple interrogator devices may be utilized in order to determine a location of a target device. In some embodiments, each of the interrogator devices may be configured to transmit an RF signal to a target device, receive a responsive RF signal from the target device (the responsive signal may have a different polarization and/or a different center frequency from the signal that was transmitted), and process the transmitted RF signal together with the received RF signal to obtain an RF signal indicative of the distance between the interrogator device and the target device. The RF signals indicative of the distances between the interrogator devices and the target device may be processed (e.g., by the interrogators or another processor) to obtain estimates of the distances between the target device and each of the interrogators. In turn, the estimated distances may be used to determine the location of the target device in 3D space.

In some embodiments, more than two interrogators may be used to interrogate a single target device. In such embodiments, estimates of distances between the target device and each of the three or more interrogators may be used to obtain the 2D location of the target devices (e.g. to specify a 2D plane containing the 3D target devices). When distances between at least three interrogator devices and a target device are available, then the 3D location of the target device may be determined.

FIG. 1B shows an illustrative system 150 that may be used to implement RF micro-localization techniques, in accordance with some embodiments of the technology described herein. The illustrative system 150 comprises a plurality of interrogators 102, which are part of a interrogator module 101. The interrogators 102 may be used to obtain estimates of distance to one or more of the target devices 104. In turn, these distance estimates (e.g., together with the known locations of the interrogators relative to one another) may be used to estimate the location(s) of the target device(s) 104.

In some embodiments, interrogator module 101 may comprise a printed circuit board (PCB) or other mechanical supports, on which the interrogators 102 may be disposed. The interrogator module 101 may be part of any product (e.g., any consumer or commercial product). The PCB or other mechanical support may be rigid or flexible. For example, the interrogator module 101 may be a computer (e.g., a desktop, a laptop, a tablet, a personal digital assistant, etc.) and the PCB may be a motherboard in the computer. As another example, interrogator module 101 may be a smartphone and the PCB may be a rigid board or a flex circuit within the smartphone. As another example, interrogator module 101 may be a camera (e.g., video camera, a camera for taking still shots, a digital camera, etc.) and the PCB may be a circuit board within the camera. As another example, the PCB may comprise a flexible circuit ribbon having one or more interrogators disposed thereon, which ribbon may be within interrogator module 101, affixed to the side of interrogator module 140 (e.g., on the side of a gaming system), or affixed near the interrogator module 101 (e.g., affixed on a wall in a room containing the product).

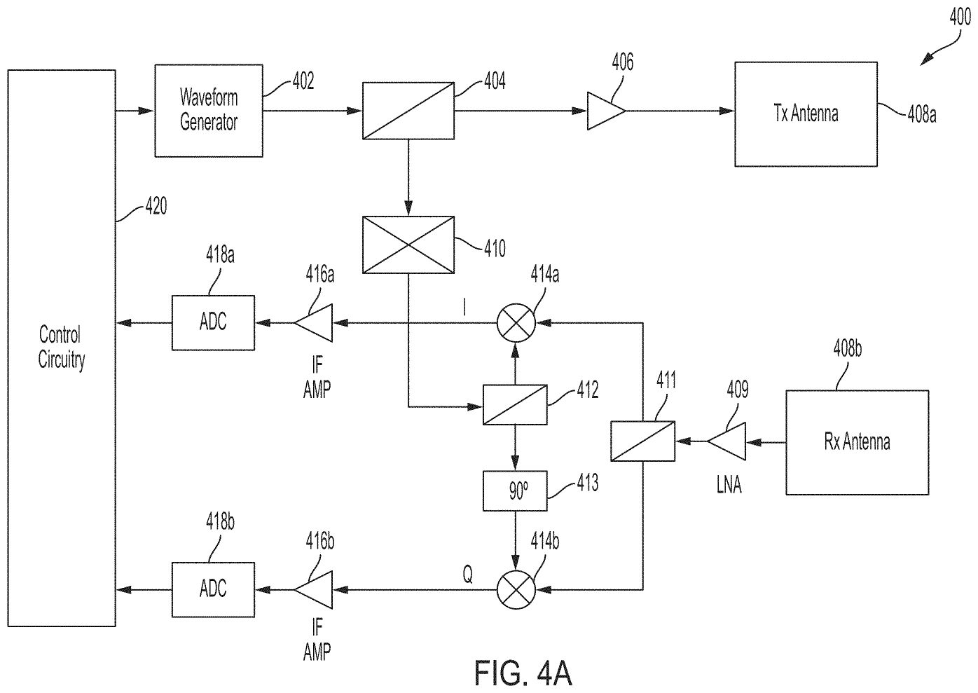

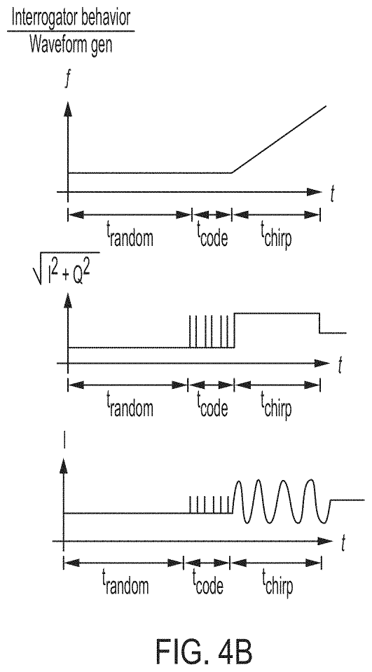

Each interrogator 102 shown in FIG. 1B may be of any suitable type described herein. In some embodiments, the interrogators 102 may be of the same type of interrogator. In other embodiments, at least two of these interrogators may be of different types. Some or all the interrogators 102 may be designed as described in connection with FIG. 4A, though in some embodiments, some of the components (e.g., waveform generator 110, control circuitry 118, external communications module 120 and/or transmit and receive circuitry 112) may be shared among multiple interrogators 102.

Although there are four interrogators shown as part of interrogator module 101, in other embodiments, any other suitable number of interrogators may be used (e.g., one, two, three, five, six, seven, eight, nine, ten, etc.), as aspects of the technology described herein are not limited in this respect. For example, in some embodiments, one interrogator 102 may be configured to transmit RF signals to a target device 104 and receive RF signals from the same target device, whereas the other interrogators 102 may be receive-only interrogators configured to receive RF signals from the target device 104, but which are not capable of transmitting RF signals to target device 104 (e.g., because these interrogators may not include transmit circuitry for generating RF signals for transmission by a transmit antenna and/or the transmission antenna). It should also be appreciated that each of target devices 104 may be of any suitable type(s) described herein, as aspects of the technology described herein are not limited in this respect.

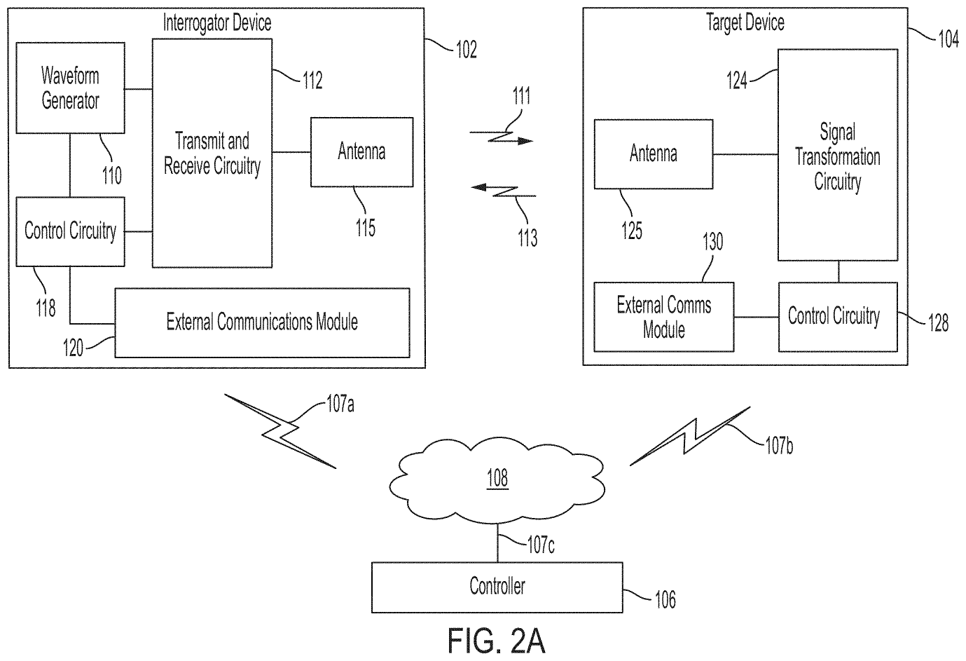

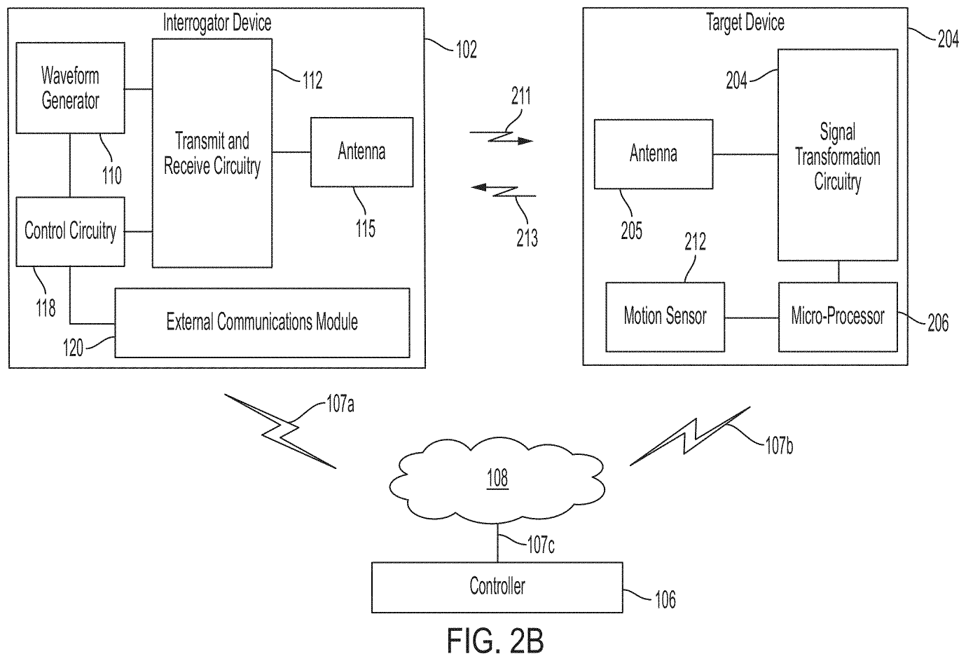

FIG. 2A shows illustrative components of an illustrative interrogator device 102 and a illustrative target device 104, which are part of the illustrative system 150 shown in FIG. 1B, in accordance with some embodiments of the technology described herein. Illustrative interrogator device 102 includes waveform generator 110, transmit and receive circuitry 112, dual-mode transmit/receive antenna 115, control circuitry 118, and external communications module 120.

It should be appreciated that, in some embodiments, an interrogator device may include one or more other components in addition to or instead of the components illustrated in FIG. 1B. Similarly, in some embodiments, a target device may include one or more other components in addition to or instead of the components illustrated in FIG. 1B. For example, in some embodiments, interrogator device 102 may have separate transmit antennas instead of the dual-mode antenna 115.

In some embodiments, waveform generator 110 may be configured to generate RF signals to be transmitted by the interrogator 102 using the antenna 115. Waveform generator 110 may be configured to generate any suitable type(s) of RF signals. In some embodiments, waveform generator 110 may be configured to generate frequency modulated RF signals, amplitude modulated RF signals, and/or phase modulated RF signals. Non-limiting examples of modulated RF signals, any one or more of which may be generated by waveform generator 110, include linear frequency modulated signals (also termed “chirps”), non-linearly frequency modulated signals, binary phase coded signals, signals modulated using one or more codes (e.g., Barker codes, bi-phase codes, minimum peak sidelobe codes, pseudo-noise (PN) sequence codes, quadri-phase codes, poly-phase codes, Costas codes, Welti codes, complementary (Golay) codes, Huffman codes, variants of Barker codes, Doppler-tolerant pulse compression signals, impulse waveforms, noise waveforms, and non-linear binary phase coded signals). Waveform generator 110 may be configured to generate continuous wave RF signals or pulsed RF signals. Waveform generator 110 may be configured to generate RF signals of any suitable duration (e.g., on the order of microseconds, milliseconds, or seconds).

In some embodiments, waveform generator 110 may be configured to generate microwave and/or millimeter wave RF signals. For example, waveform generator 110 may be configured to generate RF signals having a center frequency in a given range of microwave and/or millimeter frequencies (e.g., 4-7.5 GHz, 8-15 GHz, and 50-70 GHz). It should be appreciated that an RF signal having a particular center frequency is not limited to containing only that particular center frequency (the RF signal may have a non-zero bandwidth). For example, waveform generator 110 may be configured to generate a chirp having a center frequency of 60 GHz whose instantaneous frequency varies from a lower frequency (e.g., 59 GHz) to an upper frequency (e.g., 61 GHz). Thus, the generated chirp has a center frequency of 60 GHz and a bandwidth of 2 GHz and includes frequencies other than its center frequency.

In some embodiments, waveform generator 110 may be configured to generate RF signals using a phase locked loop. In some embodiments, the waveform generator may be triggered to generate an RF signal by control circuitry 118 and/or in any other suitable way.

In some embodiments, transmit and receive circuitry 112 may be configured to provide RF signals generated by waveform generator 110 to antenna 115 and receive and process RF signals received by the antenna 115. In some embodiments, transmit and receive circuitry 112 may be configured to: (1) provide a first RF signal to the antenna 115 for transmission to a target device (e.g., RF signal 111); (2) obtain a responsive second RF signal received by the antenna 115 (e.g., RF signal 113) and generated by the target device in response to the transmitted first RF signal; and (3) process the received second RF signal by mixing it (e.g., using a frequency mixer) with a transformed version of the first RF signal. The transmit and receive circuitry 112 may be configured to provide processed RF signals to control circuitry 118, which may (with or without performing further processing the RF signals obtained from circuitry 112) provide the RF signals to external communications module 120.

In some embodiments, the dual-mode antenna 115 may be configured to radiate RF signals circularly polarized in one rotational direction (e.g., clockwise), when operating in transmit mode, and may be configured to receive RF signals circularly polarized in another rotational direction (e.g., counter-clockwise), when operating in receive mode. In some embodiments, the dual mode antenna 115, may be configured to radiate RF signals having a first center frequency (e.g., RF signal 111 transmitted to target device 104) and receive RF signals having a second center frequency different from (e.g., a harmonic of) the first center frequency (e.g., RF signal 113 received from target device 104 and generated by target device 104 in response to receiving the RF signal 111).

In some embodiments, control circuitry 118 may be configured to trigger the waveform generator 110 to generate an RF signal for transmission by the transmit antenna 114. The control circuitry 118 may trigger the waveform generator in response to a command to do so received by external communications interface 120 and/or based on logic part of control circuitry 118.

In some embodiments, control circuitry 118 may be configured to receive RF signals from transmit and receive circuitry 112 and forward the received RF signals to external communications interface 120 for sending to controller 106. In some embodiments, control circuitry 118 may be configured to process the RF signals received from transmit and receive circuitry 112 and forward the processed RF signals to external communications interface 120. Control circuitry 118 may perform any of numerous types of processing on the received RF signals including, but not limited to, converting the received RF signals to from analog to digital (e.g., by sampling using an ADC), performing a Fourier transform to obtain a time-domain waveform, estimating a time of flight between the interrogator and the target device from the time-domain waveform, and determining an estimate of distance between the interrogator 102 and the target device that the interrogator 102 interrogated. The control circuitry 118 may be implemented in any suitable way and, for example, may be implemented as an application specific integrated circuit (ASIC), a field programmable gate array (FPGA), a combination of logic circuits, a microcontroller, or a microprocessor.

External communications module 120 may be of any suitable type and may be configured to communicate according to any suitable wireless protocol(s) including, for example, a Bluetooth communication protocol, an IEEE 802.15.4-based communication protocol (e.g., a “ZigBee” protocol), and/or an IEEE 802.11-based communication protocol (e.g., a “WiFi” protocol).

As shown in FIG. 2A, target device 104 includes dual-mode antenna 125, signal transformation circuitry 124, antenna 125, control circuitry 128, and external communications module 130. In some embodiments, the dual-mode antenna 125 may be configured to receive RF signals circularly polarized in one rotational direction (e.g., clockwise) and to transmit RF signals circularly polarized in another rotational direction (e.g., counter-clockwise).

In some embodiments, the antenna 125 may be configured to receive RF signals having a first center frequency. The received RF signals may be transformed by signal transformation circuitry 124 to obtained transformed RF signals having a second center frequency different from (e.g., a harmonic of) the first center frequency. The transformed RF signals having the second center frequency may be transmitted by the antenna 125.

In some embodiments, control circuitry 128 may be configured to turn the target device 104 on or off (e.g., by powering off one or more components in signal transformation circuitry 124) in response to a command to do so received via external communications interface 130. The control circuitry 128 may be implemented in any suitable way and, for example, may be implemented as an application specific integrated circuit (ASIC), a field programmable gate array (FPGA), a combination of logic circuits, a microcontroller, or a microprocessor. External communications module 130 may be of any suitable type including any of the types described herein with reference to external communications module 120.

FIG. 2B shows illustrative components of an interrogator device and a low-power target 204 device without a dedicated control channel, which may be part of the illustrative system 150 shown in FIG. 1B, in accordance with some embodiments of the technology described herein. Unlike target device 104 shown in FIG. 2A, target device 204 includes a processor 206 instead of control circuitry 128 and external communications interface 130. In the illustrated embodiment, processor 206 is configured to turn the target device 204 on or off by coupling one or more components in signal transformation circuitry 204 to a power source 210 (e.g., a button cell battery or any other suitable type of battery).

In some embodiments, processor 206 may be configured to periodically (e.g., on average approximately at a rate of 1 Hz): (1) wake up the target device 204 by coupling the signal transformation circuitry to power source 210; (2) cause the target device to transmit a code associated with the target device 204 to an interrogator using on-off keying (OOK); and (3) cause the target device to stay on for a specified period of time (e.g., 1 ms) so that the interrogator can ping the target device with a waveform to determine the time-of-flight and/or distance between the interrogator and the target device.

In some embodiments, the processor 206 may be a low-power micro-processor or micro-controller and, for example, may be an AVR ATtiny 10 microcontroller (e.g., an AVR® ATtiny Microcontroller IC 8-Bit 12 MHz 1 KB (512×16) FLASH SOT-23-6), in some embodiments. In some embodiments, the low-power micro-processor may consume less than 500 microamps (μA) (or less than 400 μA, less than 300 μA, less than 200 μA) at 1 MHz and 1.8V in active mode.

As shown in the embodiment of FIG. 2B, the target device 204 further has a motion sensor 212. The motion sensor may include an accelerometer, a gyroscope, an IMU and/or any other suitable motion sensor. In some embodiments, the processor 206 may receive one or more signals from the motion sensor 212 indicating that the motion sensor 212 detected motion of the target device 204. In response, in some embodiments, the processor 204 may wake up the target device 204 (e.g., by coupling the signal transformation circuitry to power source 210), cause the target device 204 to transmit a code associated with the target 204 to an interrogator (e.g., using OOK), and cause the target device to stay on for a specified period of time so that the interrogator can ping the target device with a waveform to determine the time-of-flight and/or distance between the interrogator and the target device.

In some embodiments, additionally or alternatively, the processor 206, in response to receiving signal(s) from the motion sensor 212, may change the schedule according to which it causes the target device 204 to wake up and communicate with the interrogator (e.g., by transmitting its code using OOK and waiting to be pinged by the interrogator). For example, the processor 206 may change the schedule from randomly waking up the target device 204 at a first rate (e.g., every 10 seconds) to waking up at a higher second rate (e.g., every half a second), thereby increasing the frequency at which the target device attempts to communicate with the interrogator. In some embodiments, the processor 206 may change the schedule back to using the first rate (e.g., waking up the target device every 10 seconds) after a threshold amount of time elapsed from when the motion sensor 212 last detected motion of the target device.

It should be appreciated that although the embodiment of FIG. 2B illustrates the target device 204 as having a motion sensor 212, other embodiments of the target device may not include a motion sensor.

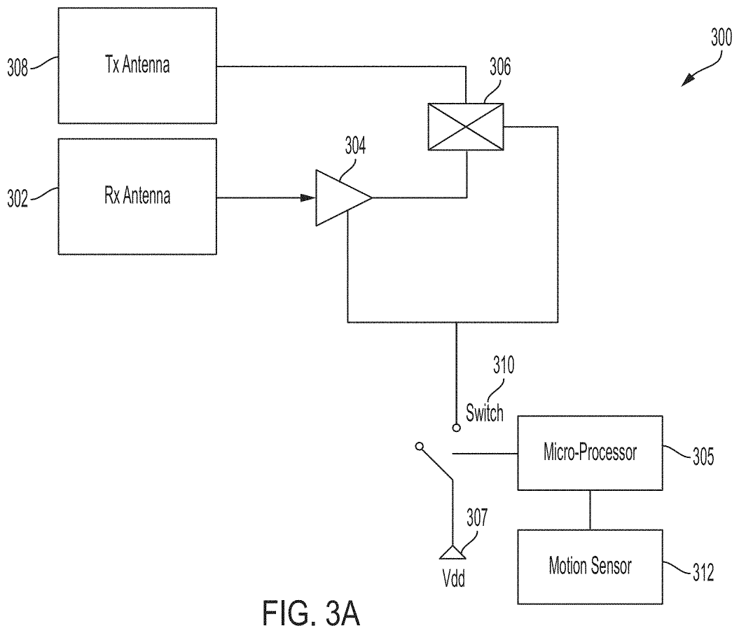

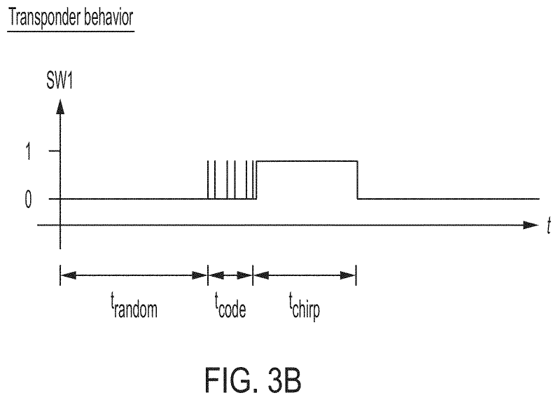

FIG. 3A shows illustrative components of a low-power target device 300, in accordance with some embodiments of the technology described herein. The target device 300 includes a receive antenna 302, an amplifier 304, a frequency doubler 306, and a transmit antenna 308. In the illustrated embodiment, power to one or more components in the signal chain between the transmit and receive antennas is provided from voltage source 307 (e.g., a battery). For example, as shown in FIG. 3A, power to the amplifier 304 and frequency doubler 306 is provided from voltage source 307. In some embodiments, the battery may be a button cell battery such, as for example, a 1000 mAh CR2477 button cell battery or a CR3202 battery.

As shown in FIG. 3A, low-power target device 300 further includes a processor 305, which is configured to control when power is provided to the one or more components in the target device's signal chain between the transmit and receive antennas (e.g., amplifier 304 and frequency doubler 306) by controlling switch 310. In the example target device 300, opening the switch 310 cuts off power to the amplifier 304 and frequency doubler 306, while closing the switch provides power to these components. In this way, processor 305 may be configured to modulate one or more of the components in the signal chain of target device 300 by turning them and on off. This, in turn, allows the processor 305 to modulate the RF signals received by antenna 302 using on-off keying (OOK), which is a form of amplitude-shift keying (ASK).

In some embodiments, processor 305 may be a low-power microprocessor or microcontroller. For example, processor 305 may be an AVR ATTINY 10 microcontroller (e.g., an AVR® ATtiny Microcontroller IC 8-Bit 12 MHz 1 KB (512×16) FLASH SOT-23-6), in some embodiments. In some embodiments, the low-power micro-processor may consume less than 500 μA (or less than 400 μA, less than 300 μA, less than 200 μA) at 1 MHz and 1.8V in active mode.

In some embodiments, the processor 305 may be configured to wake up at a random time (e.g., on average every 500 milliseconds, on average every second, on average once every two seconds, etc.), modulate the target device according to a code (e.g., a unique asynchronous code associated with the target device) associated with the target device using OOK implemented via switch 310 as described above, and leave the target device on for a specified duration of time (e.g., at least 500 microseconds, at least 1 ms, at least 2 ms, etc.) for a ranging chirp from an interrogator (e.g., an LFM chirp).

Accordingly, in some embodiments, the target device may be configured to wake itself up at a random time (t_random) corresponding to a specified average time between consecutive (e.g., an average of 1 second between wake-ups so that the target device wakes up at a rate of approximately 1 Hz on average). To this end processor 305 may be configured to generate a series of wake-up signals such that the average time between the wake-up signals is on average approximately a specified duration of time (e.g., 1 second).

In some embodiments, in response to generating a particular wake-up signal, the processor 305 may be configured to pulse modulate itself, during the time period “t_code” using OOK with a unique code that may be detected by an interrogator in communication with the target device. Upon completing modulation with a code, the processor 305 may be configured to close switch 310 to keep the signal chain powered for a period of time “t_chirp” during which an interrogator may range the target device using an LFM waveform, which would therefore allow determination of the location of the target device and its unique code. This behavior is further illustrated in FIG. 3B, which is a timing diagram illustrating when power is provided to multiple components of the low-power target device 300, in accordance with some embodiments of the technology described herein.

As shown in the embodiment of FIG. 3A, the target device 300 further has a motion sensor 312. The motion sensor may include an accelerometer, a gyroscope, an IMU and/or any other suitable motion sensor. In some embodiments, the processor 305 may receive one or more signals from the motion sensor 312 indicating that the motion sensor 312 detected motion of the target device 300. In response, in some embodiments, the processor 204 may wake up the target device 300 (e.g., by coupling the signal transformation circuitry to voltage source 307), cause the target device 300 to transmit a code associated with the target 300 to an interrogator (e.g., using OOK), and cause the target device to stay on for a specified period of time so that the interrogator can ping the target device with a waveform to determine the time-of-flight and/or distance between the interrogator and the target device.

In some embodiments, additionally or alternatively, the processor 305, in response to receiving signal(s) from the motion sensor 312, may change the schedule according to which it causes the target device 300 to wake up and communicate with the interrogator (e.g., by transmitting its code using OOK and waiting to be pinged by the interrogator). For example, the processor 305 may change the schedule from randomly waking up the target device 300 at a first rate (e.g., every 10 seconds) to waking up at a higher second rate (e.g., every half a second), thereby increasing the frequency at which the target device attempts to communicate with the interrogator. In some embodiments, the processor 305 may change the schedule back to using the first rate (e.g., waking up the target device every 10 seconds) after a threshold amount of time elapsed from when the motion sensor 312 last detected motion of the target device.

It should be appreciated that although the embodiment of FIG. 3A illustrates the target device 300 as having a motion sensor 312, other embodiments of the target device may not include a motion sensor.

In some embodiments a low-power target device may be implemented as integrated circuitry on a semiconductor chip. In some embodiments, the chip may be manufactured using a CMOS process, a SiGen CMOS process, or a SiGe HBT BiCMOS process. The resulting small form factor may allow the low-power target device to be integrated into an identification badge, for example, in the context of applying the techniques described herein to enabling access control for personnel (e.g., unlocking a door when an employee with a badge having a code associated with the employee is within a threshold distance of the door) and/or tracking the location of personnel (e.g., tracking the location of employees in a building). Other applications include tracking of shipping labels, safety systems (e.g., on factory floors), etc.

In some embodiments, a micro-location system may be implemented using multiple channels (e.g., four channels), one or more of which may be both a transmit channel and a receive channel. For example, as shown in FIG. 1B, in some embodiments, an interrogator device may support four channels one of which may be a transmit and receive channel with the remaining three channels being receive-only channels. For clarity of exposition, let's consider a single-channel interrogator 400 providing both real and imaginary (quadrature) data, in accordance with some embodiments of the technology described herein. It should be appreciated, however, that an interrogator is not limited to being a single-channel interrogator and, in some embodiments, an interrogator may have multiple channels one or more of which may be transmit and receive channels.

As shown in FIG. 4A, interrogator 400 includes a signal transmit chain including waveform generator 402, 1-2 splitter 404, amplifier 406, and transmit antenna 408a. The interrogator 400 further includes a receive chain including receive antenna 408b, amplifier 409, 1-2 splitter 411, frequency doubler 410 (which may be the same type of doubler as frequency doubler 306 shown in FIG. 3A), 1-2 splitter 412, mixers 414a and 414b, intermediate frequency (IF) amplifiers 416a and 416b, and ADCs 418a and 418b. The data provided by the ADCs 418a and 418b may be provided to control circuitry 420.

In some embodiments, the waveform generator 402 may be configured to generate various waveforms including continuous wave (CW) unmodulated waveforms and linear frequency modulated (LFM) waveforms. In some embodiments, the control circuitry 420 may be configured to control which waveform is generated by waveform generator 402. For example the control circuitry 420 may control the waveform generator 402 to generate a continuous wave (CW) unmodulated waveform or a linear frequency modulated (LFM) waveform depending on the state of a target device in communication with the interrogator 400, as described herein.

In some embodiments, the waveform generator is set (e.g., by control circuitry 420) to output a CW unmodulated waveform when the system is idle and is waiting for a target device to wake itself up. As described herein, in some embodiments, a low-power microprocessor may control the target device and may wake it up at a series of random times with the average time between wake-ups (“t_delay”) being set to achieve an average desired ping rate. In some embodiments, upon waking up, the microprocessor may modulate the target device on and off using OOK according to a code associated with the target device. This occurs during the time interval “t_code.” In turn, the interrogator receives this code as a series of pulses.

In some embodiments, in response to detecting transmission of a complete code from a target device (and, in some embodiments, further upon determining that the detected code is one of a group of defined codes, for example, a group of codes for a corresponding group of employees), the control circuitry triggers the waveform generator 402 to transmit an LFM chirp to the target device so as to obtain measurements that may be used to determine the distance between the interrogator and the target device. The target device receives the LFM chirp and re-transmits it back to the interrogator after passing it through its signal chain including the frequency doubler (e.g., frequency doubler 306). In turn, the interrogator uses the responsive chirp together with a version of the transmitted chirp to determine a time of flight and/or distance between the interrogator and the target device.

FIG. 4B illustrates aspects of interrogator behavior when a target device randomly turns on, pulses its code, and remains on so as to be ranged with a linear FM chirp, in accordance with some embodiments of the technology described herein. The top panel of FIG. 4B is a plot of frequency vs. time of the waveform generated by the waveform generator 402. The top panel shows that the interrogator 400 generates a CW unmodulated waveform having a fixed frequency during the time periods “t_random” and “t_code” until the interrogator 400 recognizes a complete code from a target device. After the interrogator recognizes the code from the target device, the waveform generator 402 generates a linear frequency chirp during the time period “t_chirp”.

The middle panel of FIG. 4B shows a plot of the absolute magnitude of the intermediate frequency (IF) output from the interrogator during the time periods “t_random”, “t_code”, and “t_chirp”. No signal from the target device is detectable by the interrogator during the time period “t_random” since the signal chain of the target device is not powered during this time. The interrogator device detects and reads asynchronous pulses of a code from the target device during the time period “t_code”. After the complete code is read, the interrogator transmits an LFM chirp, during the time period “t_chirp” to measure a range to the target device.

The bottom panel of FIG. 4B shows the real value of the IF output from the interrogator (just the I channel), which shows no signal being received during the time period “t_random”, spikes due to the code modulation during the time period “t_code”, followed by a sinusoidal waveform that is the spatial frequency representation of the target device range during the time period “t_chirp”.

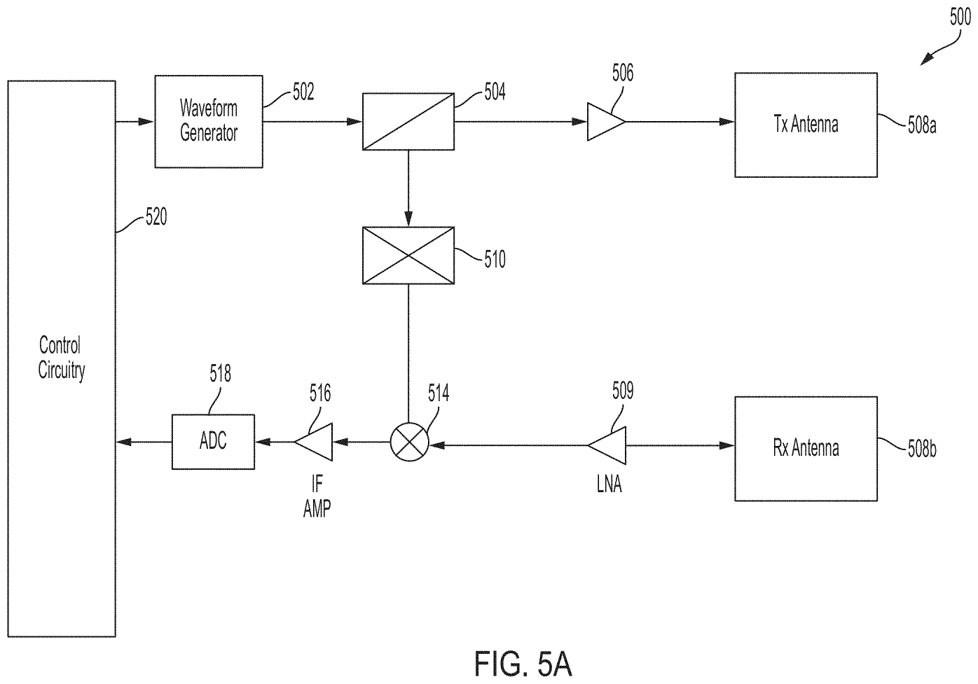

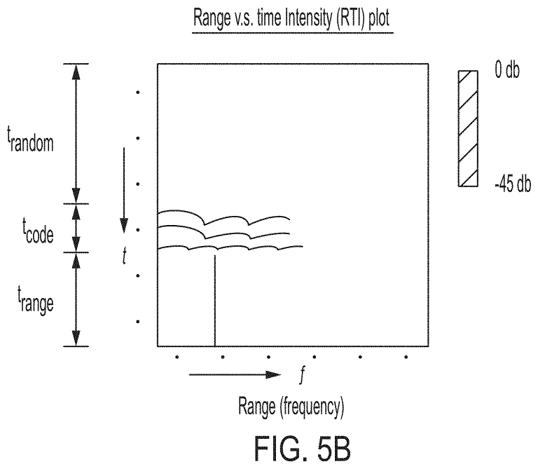

FIG. 5A shows illustrative components of a single-channel interrogator transmitter/receiver 500 providing real data, in accordance with some embodiments of the technology described herein. The inventors have recognized that using only real-valued signals (e.g., in an interrogator that only has an I channel, without a quadrature architecture) it may be difficult to measure the instantaneous amplitude of any pulse coded waveforms received from the target device. In such embodiments, a different signal processing technique may be used whereby the discrete Fourier transform (DFT) of the real-valued data are processed over multiple short intervals of time. For example, in some embodiments, the DFTs for multiple short intervals may be stacked on top of each other in a “waterfall” plot (sometimes called a “range-time intensity” (RTI) plot or a “range spectrum”) which shows the evolution of the frequency spectrum vs time. An example of such a plot is shown in FIG. 5B.

During the random time delay period “t_random”, it is expected that a low-noise signal will be present on the stack of DFTs. When a target device transmits a code during the time period “t_code” the spectrum will pop up and down showing one-half of the Fourier Transform of a pulse modulated sinewave (which is a sinc function) folded onto itself and centered at 0 Hz. This spectral response reveals when the target device is pulsed on and when it is pulsed off, which allows for the reading of the target device's code. Finally, during the time period “t_chirp when the target device is on for ranging, the range to the target device will be shown by and may be identified from the range spectrum.

The inventors have further analyzed the performance of some embodiments of a low-power target device described herein. For the analysis, it will be assumed that the target device is operating at a 0.1% duty cycle (1 position per second for a 1 ms ping time), and that a 1000 mAh (CR2477) coin cell battery is used to power the target device. It is further assumed that the ranging is performed at a maximum distance of 30 meters. Under these assumptions, the performance is summarized in the following table.

| | |
|---|---|
| Battery type | 1000 mAh CR2477 button cell |
| Average power consumption | 500 uW at 2.5 V, 200 uA |
| Control Radio Protocol | No control radio, random asynchronous on- |
| | off keying (OOK) modulation of target device |
| | itself as preamble to a ranging ping (with an |
| | LFM waveform) |
| Ping Rate | 1 Hz (0.1% duty cycle at 1000 pings per |
| | second) |
| Maximum Range | 30 m |
| Range Precision at 30 m (can use geometric | 600 um single-sigma STD for one ping (no |
| dilution of precision (GDOP) to compute | averaging) |
| position precision given various geometries) | |
| Target device life expectancy | 208.3 days |
| Form factor | >=diameter of CR2477 or 11 × 11 mm chip |
| | package plus enclosure |

Varying the duty cycle in the above analysis leads to the following modifications:
100% duty cycle→target device life expectancy of 5 hours
10% duty cycle (100 positions/second)→target device life expectancy of 50 hours
2% duty cycle (20 positions/second)→target device life expectancy of 250 hours
0.1% duty cycle (1 position/second)→target device life expectancy of 5000 hours

The inventors have further appreciated that if the target device were designed using SiGe architecture and optimized for low power, then the target device's life expectancy would be 7042 hours at a 0.1% duty cycle. Further optimizing the design for CMOS and low power consumption would reduce the power by an additional factor of approximately 2.5 lead to a target device life expectancy of 12,500 hours (520.8 days or 1.4 years) at a 0.1% duty cycle. In the CMOS design, if an even smaller battery were used (e.g., a CR3202 battery), the target device would have a life expectancy of 2812.5 hours (117 days) at a 0.1% duty cycle.

Having thus described several aspects some embodiments, it is to be appreciated that various alterations, modifications, and improvements will readily occur to those skilled in the art. Such alterations, modifications, and improvements are intended to be within the spirit and scope of the present disclosure. Accordingly, the foregoing description and drawings are by way of example only.

The above-described embodiments of the present disclosure can be implemented in any of numerous ways. For example, one or more of the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the concepts disclosed herein may be embodied as a non-transitory computer-readable medium (or multiple computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the present disclosure discussed above. The computer-readable medium or media can be transportable, such that the program or programs stored thereon can be loaded onto one or more different computers or other processors to implement various aspects of the present disclosure as discussed above.

The terms “program” or “software” are used herein to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various features and aspects of the present disclosure may be used alone, in any combination of two or more, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The terms “approximately”, “substantially,” and “about” may be used to mean within ±20% of a target value in some embodiments, within ±10% of a target value in some embodiments, within ±5% of a target value in some embodiments, and within ±2% of a target value in some embodiments. The terms “approximately” and “about” may include the target value.

What is claimed is:

1. A device comprising:
a receive antenna configured to receive radio-frequency (RF) signals having a first center frequency;
a transmit antenna configured to transmit radio-frequency (RF) signals having a second center frequency that is a harmonic of the first center frequency; and
a processor configured to:
generate a plurality of wake-up signals at a respective plurality of random times; and
for each one of the plurality of wake-up signals,
in response to generating the each one wake-up signal, cause the transmit antenna to transmit an RF signal having the second center frequency and indicating a code associated with the device to an interrogator device different from the device.

2. The device of claim 1, wherein the processor is configured to generate the plurality of wake-up signals using a pseudo-random number generator.

3. The device of claim 1, wherein the processor is configured to generate the plurality of wake-up signals such that a wake-up signal is generated, on average, at a rate equal to a specified ping rate.

4. The device of claim 3, wherein the specified ping rate is a rate in a range of 0.1 Hz and 200 Hz.

5. The device of claim 1, wherein the processor is configured to generate the plurality of wake-up signals such that a time between successive wake-up signals is, on average, approximately a specified duration.

6. The device of claim 1, wherein the processor is configured to cause the transmit antenna to transmit the RF signal having the second center frequency at least in part by:
modulating a received RF signal received by the receive antenna using the code associated with the device.

7. The device of claim 1, further comprising:
a substrate, wherein the receive antenna and the transmit antenna are fabricated on the substrate;
a semiconductor die mounted on the substrate; and
circuitry integrated with the semiconductor die mounted on the substrate and configured to:
generate, from RF signals provided from the receive antenna and having the first center frequency, RF signals having the second center frequency, and
provide the generated RF signals having the second center frequency to the second transmit antenna.

8. The device of claim 1, wherein the first center frequency is in a range of 50-70 GHz and the second center frequency is in a range of 100-140 GHz.

9. The device of claim 1, wherein the device is configured to operate at less than 1 milliWatt.

10. The device of claim 1, wherein the device is configured to operate at less than 500 microWatts.

11. A method, performed by a device comprising a receive antenna configured to receive RF signals having a first center frequency, a transmit antenna configured to transmit RF signals having a second center frequency that is a harmonic of the first center frequency, and a processor, the method comprising:
generating a plurality of wake-up signals at a respective plurality of random times; and
for each one of the plurality of wake-up signals,
in response to generating the each one wake-up signal, causing the transmit antenna to transmit an RF signal having the second center frequency and indicating a code associated with the device to an interrogator device different from the device.

12. The method of claim 11, wherein generating the plurality of wake-up signals is performed using a pseudo-random number generator, and wherein generating the plurality of wake-up signals comprises generating a wake-up signal, on average, at a rate equal to a specified ping rate.

13. The method of claim 11, wherein the specified ping rate is in a range of 0.1 Hz and 200 Hz.

14. The method of claim 11, wherein causing the transmit antenna to transmit the RF signal having the second center frequency comprises:
modulating a received RF signal received by the receive antenna using the code associated with the device using amplitude modulation, pulse modulation, or phase modulation.

15. The method of claim 11, wherein the received RF signal is a continuous wave RF signal having the first center frequency.

16. The method of claim 11, wherein the plurality of wake-up signals includes a first wake-up signal, the method further comprising:
in response to generating the first wake-up signal, causing the transmit antenna to transmit a first RF signal having the second center frequency and indicating the code associated with the device to the interrogator device,
after transmitting the first RF signal,
receiving, from the interrogator device, a second RF signal having the first center frequency;
generating, using the second RF signal and signal transformation circuitry part of the target device, a third RF having the second center frequency; and
transmitting, to the interrogator device, the third RF signal having the second center frequency.

17. The method of claim 11, wherein the first center frequency is in a range of 50-70 GHz and the second center frequency is in a range of 100-140 GHz.

18. An interrogator device, comprising:
a transmit antenna configured to transmit RF signals having a first center frequency;
a receive antenna configured to receive RF signals having a second center frequency that is a harmonic of the first center frequency;
circuitry configured to provide RF signals to the transmit antenna and receive RF signals from the receive antenna; and
a controller configured to, in response to determining that the interrogator device received a first RF signal indicating a first code associated with a first target device, cause the interrogator device to:
transmit a second RF signal to the first target device using the transmit antenna, the second RF signal having the first center frequency;
receive a third RF signal from the first target device, the third RF signal having the second center frequency; and
generate, based on the second RF signal and the third RF signal, a fourth RF signal indicative of a time-of flight and/or distance between the interrogator device and the first target device.

19. The interrogator device of claim 18,
wherein the controller is further configured to, in response to determining that the interrogator device received a fifth RF signal indicating a second code associated with a second target device, cause the interrogator device to:
transmit a sixth RF signal to the second target device using the transmit antenna, the sixth RF signal having the first center frequency;
receive a seventh RF signal from the second target device, the seventh RF signal having the second center frequency; and
generate, based on the sixth RF signal and the seventh RF signal, an eighth RF signal indicative of a time-of flight and/or distance between the interrogator device and the second target device.

20. The interrogator device of claim 18, wherein the second RF signal is a linear frequency modulated signal.
